(19) United States
(12) Patent Application Publication
(10) Pub. No.: US 2001/0037160 A1
(43) Pub. Date: Nov. 1, 2001

(54) Crosstalk cancellation circuit, interconnection module, interconnection method of automatic interconnection apparatus, and integrated circuit

(76) Inventor: Ichiro Kumata, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 09/824,040

(22) Filed: Apr. 3, 2001

(30) Foreign Application Priority Data
Apr. 4, 2000 (JP) P2000-106705

(51) Int. Cl. G06F 17/00; H04R 5/00

(52) U.S. Cl. 700/94; 381/1; 381/66

(57) ABSTRACT

A crosstalk cancellation circuit for suppressing crosstalk noise of interconnections in an integrated circuit, comprising N (N is an even number of 2 or more) number of first inverters, a first interconnection for connecting the N number of first inverters in series, N number of second inverters, and a second interconnection for connecting the N number of second inverters in series, wherein the first and second interconnections are arranged adjacent in parallel to each other, at least one first inverters is arranged at a location where crosstalk noise due to a parasitic capacity between the first and second interconnections is canceled out on the second interconnection, and at least one second inverter is arranged at a location where the crosstalk noise is canceled out on the first interconnection.

### BACKGROUND OF THE INVENTION

1. Field of the Invention

The present invention relates to a crosstalk cancellation circuit capable of suppressing crosstalk noise of interconnections in a large scale integrated circuit (LSI), an interconnection module useable in this crosstalk cancellation circuit, a method of interconnection of an automatic interconnection apparatus for laying out the interconnections in an LSI, and an integrated circuit having the crosstalk cancellation circuit.

2. Description of the Related Art

In long distance interconnections such as buses or inter-block interconnections in an LSI, crosstalk occurs due to the parasitic capacity between adjoining interconnections. Due to this crosstalk, variations occur in the signal propagation delay, so there is a possibility of hold time error in a D-type flip-flop (DFF) in the LSI, a reduction of the highest operating frequency of the LSI, and so on.

There have been various disclosures concerning crosstalk.

For example, Japanese Unexamined Patent Publication (Kokai) No. 10-32254 discloses inventions of an automatic interconnection method of a semiconductor device and a method of calculation of a net delay.

Japanese Unexamined Patent Publication (Kokai) No. 11-40677 discloses inventions of a system and method for reducing crosstalk error.

Japanese Unexamined Patent Publication (Kokai) No. 9-293094 discloses an invention of a layout designing apparatus.

Japanese Unexamined Patent Publication (Kokai) No. 10-308451 discloses an invention of an automatic interconnection method considering crosstalk.

Summarizing the disadvantages to be solved in the invention, one known method of dealing with crosstalk is to shield a signal line or increase the interconnection interval, but if this method is used, an increase of the interconnection region (interconnection area) is caused.

Another method of dealing with crosstalk is to insert buffers at equal intervals at the interconnections and line up the buffers in a direction orthogonal to the interconnection direction so as to reduce the ratio of the parasitic capacity with respect to the load capacity and reduce the influence of the crosstalk. If this method is used, however, the larger the number of the buffers, the larger the interconnection area and the consumed power.

When the number of the buffers is increased to an extent that the influence of the crosstalk can be sufficiently reduced and the buffer interval can be reduced, the overall delay time including also the buffers becomes large.

Another method, when two signal lines are arranged adjoining to each other in parallel over a long distance, is to shift one signal line to another interconnection layer or switch it in position midway with another parallel interconnection at a location away from it in the identical interconnection layer. If this method is used, however, the at least one first inversion circuits and the at least one second inversion circuits are alternately arranged in an interconnection direction. number of extra interconnections is increased for switching positions.

With this method, the possibility of reduction of the influence of the crosstalk is statistically high. However, when crosstalk from the adjoining interconnection at a position after the switch and crosstalk from the adjoining interconnection before the switch occur simultaneously and at the same phase, the crosstalk may not be suppressed so much in the worst case. It takes time and effort to verify the effects of crosstalk by all combinations including the timings of the dynamic changes of the signal. The load is also great.

### SUMMARY OF THE INVENTION

An object of the present invention is to provide a crosstalk cancellation circuit capable of suppressing crosstalk noise of interconnections in a large scale integrated circuit, an interconnection module useable in this crosstalk cancellation circuit, a method of interconnection of an automatic interconnection apparatus capable of laying interconnections of the crosstalk cancellation circuit in the LSI, and an integrated circuit having the crosstalk cancellation circuit.

According to a first aspect of the present invention, there is provided a crosstalk cancellation circuit for suppressing crosstalk noise of interconnections in an integrated circuit, having N (N is an even number of 2 or more) number of first inversion circuits, a first interconnection for connecting the N number of first inversion circuits in series, N number of second inversion circuits, and a second interconnection for connecting the N number of second inversion circuits in series, wherein the first and second interconnections are arranged adjacent in parallel or substantially parallel to each other, at least one first inversion circuits among the N number of first inversion circuits is arranged at a location where crosstalk noise due to a parasitic capacity between the first and second interconnections is canceled out or substantially canceled out on the second interconnection, and at least one second inversion circuit among the N number of second inversion circuits is arranged at a location where crosstalk noise due to a parasitic capacity between the first and second interconnections is canceled out or substantially canceled out on the first interconnection.

Preferably the N number of first inverters are arranged in the approximately same interval in the first interconnection, and the N number of second inverters are arranged in the second interconnection at the middle positions where distances from the adjacent first inverters are equal.

Preferably, in each of the N number of first inversion circuits, a time when an input signal voltage of the related first inversion circuit changes and a time when an output signal voltage changes overlap, and in each of the N number of second inversion circuits, a time when the input signal voltage of the related second inversion circuit changes and a time when the output signal voltage changes overlap.

Specifically, the N number of first and second inversion circuits and the first and second interconnections comprise buses such as data buses or address buses in the integrated circuit.

Preferably the N number of first and second inversion circuits are inversion circuits having the same configuration.

According to a second aspect of the present invention, there is provided an interconnection module in an integrated circuit, comprising M (M is a natural number) number of inversion circuits, input lines of the M number of inversion circuits, output lines of the M number inversion circuits and L number of signal lines, wherein the input lines, the output lines, and the signal lines are parallel or substantially parallel to each other, and the inversion circuits, input lines, and output lines of the related inversion circuits and the signal lines are alternately arranged. Note, where M=1, L=M or L=M+1 and where M≧2, L=M, L=M+1, or L=M−1.

Preferably, M is an integer of 2 or more, and the M number of inversion circuits are arranged so as to be parallel in a direction vertical or substantially vertical to the direction of the signal lines.

Specifically, the integrated circuit is configured as a semiconductor integrated circuit manufactured by a process rule of less than 0.25 micrometer.

According to a third aspect of the present invention, there is provided a method of interconnection of an automatic interconnection apparatus for laying out interconnections in an integrated circuit, comprised of a first step of arranging a plurality of interconnections parallel or substantially parallel and a second step of inserting the same number of inversion circuits at the plurality of interconnections, the second step having a third step of inserting each inversion circuit at a location where crosstalk noise due to a parasitic capacity of the adjoining interconnections is canceled out or substantially canceled out on the related adjoining interconnections.

Preferably, in the third step, the inversion circuits are inserted at alternate locations with respect to the interconnections adjoining each other among the plurality of interconnections.

More preferably, in the third step, each inversion circuit is inserted at one interconnection between interconnections adjoining each other at a location where the distance from the inversion circuit of the other interconnection becomes the maximum or in the vicinity of that location.

More preferably, a time difference between the maximum delay time and the minimum delay time in a case where the inversion circuits are arranged at alternate locations with respect to the adjoining two interconnections is not more than a half of the time difference between the maximum delay time and the minimum delay time in a case where each two related inversion circuits are arranged in line in a direction vertical to the interconnection direction.

Preferably, in the inversion circuit, a time when an input signal voltage changes and a time when an output signal voltage changes overlap.

Specifically, the interconnections are interconnections of data buses or address buses.

Further specifically, the integrated circuit is configured as a semiconductor integrated circuit manufactured by the process rule of less than 0.25 micrometer.

Preferably, the inversion circuits inserted at the plurality of interconnections are inversion circuits having the same configuration.

According to a forth aspect of the present invention, there is provided an integrated circuit comprising a crosstalk cancellation circuit for suppressing crosstalk noise of interconnections in an integrated circuit, and wherein the crosstalk cancellation circuit comprises N (N is an even number of 2 or more) number of first inverters, a first interconnection for connecting the N number of first inverters in series, N number of second inverters, and a second interconnection for connecting the N number of second inverters in series, and wherein the first and second interconnections are arranged adjacent in parallel or substantially parallel to each other, wherein at least one first inverters among the N number of first inverters is arranged at a location where crosstalk noise due to a parasitic capacity between the first and second interconnections is canceled out or substantially canceled out on the second interconnection, and wherein at least one second inverter among the N number of second inverters is arranged at a location where crosstalk noise due to a parasitic capacity between the first and second interconnections is canceled out or substantially canceled out on the first interconnection.

By arranging any of the N number of first inversion circuits at a location where crosstalk noise due to the parasitic capacities between the first and second interconnections is canceled out or substantially canceled out on the second interconnection, the crosstalk noise on the second interconnection is canceled out and consequently the crosstalk noise is reduced.

By arranging any of the N number of second inversion circuits at a location where the crosstalk noise due to the parasitic capacities between the first and second interconnections is canceled out or substantially canceled out on the first interconnection, the crosstalk noise on the first interconnection is canceled out and consequently the crosstalk noise is reduced.

### BRIEF DESCRIPTION OF THE DRAWINGS

These and other objects and features of the present invention will become more apparent from the following description of the preferred embodiments given in relation to the attached drawings, wherein:

FIG. 1 is a circuit diagram of a crosstalk cancellation circuit according an embodiment of the present invention;

FIGS. 2A and 2B are circuit diagrams of examples of an inversion circuit in FIG. 1;

FIGS. 3A and 3B are explanatory views of a crosstalk suppression circuit of the related art;

FIG. 4 is an explanatory view illustrating a change of an input signal voltage and an output signal voltage of the inversion circuit in FIG. 1 along with time;

FIGS. 5A and 5B are explanatory views of the state of cancellation of crosstalk noise, in which FIG. 5A is a partial circuit diagram showing enlarged the vicinity of an inversion circuit 11 in FIG. 1, and FIG. 5B is a schematic equivalent circuit diagram taking into account the interconnection resistance and parasitic capacity in the partial circuit diagram of FIG. 5A;

FIGS. 6A to 6E are first explanatory views of interconnection modules useable in a crosstalk cancellation circuit and a crosstalk cancellation circuit created from the related interconnection modules;

FIGS. 7A to 7C are second explanatory views of interconnection modules useable in a crosstalk cancellation circuit and a crosstalk cancellation circuit created from the related interconnection modules;

FIG. 8 is a schematic flowchart of a first interconnection method of an automatic interconnection apparatus for laying out interconnections in an LSI which lays out interconnections of the crosstalk cancellation circuit; and

FIG. 9 is a schematic flowchart of a second interconnection method of an automatic interconnection apparatus for laying out interconnections in an LSI which lays out interconnections of the crosstalk cancellation circuit by using the interconnection module.

### DESCRIPTION OF THE PREFERRED EMBODIMENTS

Below, embodiments of the present invention will be explained by referring to the attached drawings.

Crosstalk Cancellation Circuit

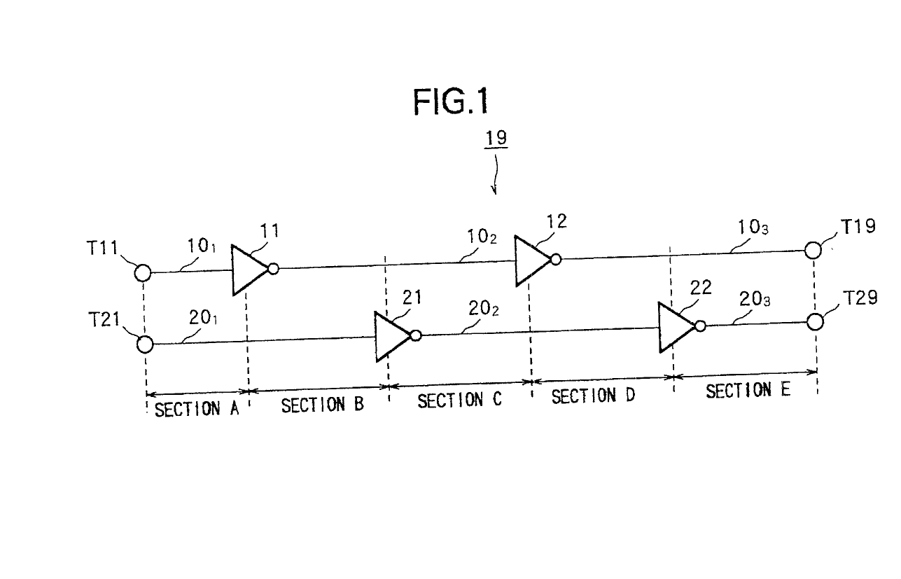

FIG. 1 is a circuit diagram of an embodiment of a crosstalk cancellation circuit according to the present invention.

This crosstalk cancellation circuit 19 has input ends T11 and T21, output ends T19 and T29, interconnections 10₁ to 10₃ and 20₁ to 20₃, and inversion circuits 11, 12, 21, and 22 and is used in an LSI.

The inversion circuits 11, 12, 21, and 22 are comprised of for example NAND gates, NOR gates, inverters, etc.

The input end T11 and the input end of the inversion circuit 11 are connected by the interconnection 10₁.

The output end of the inversion circuit 11 and the input end of the inversion circuit 12 are connected by the interconnection 10₂.

The output end of the inversion circuit 12 and the output end T19 are connected by the interconnection 10₃.

The input end T21 and the input end of the inversion circuit 21 are connected by the interconnection 20₁.

The output end of the inversion circuit 21 and the input end of the inversion circuit 22 are connected by the interconnection 20₂.

The output end of the inversion circuit 22 and the output end T29 are connected by the interconnection 20₃.

The interconnections 10₁ to 10₃ and the interconnections 20₁ to 20₃ are arranged parallel or substantially parallel.

The inversion circuits 11 and 12 are inserted among the interconnections 10₁ to 10₃, and the inversion circuits 21 and 22 are inserted among the interconnections 20₁ to 20₃.

In the circuit diagram of FIG. 1, among the interconnections 10₁ to 10₃ and 20₁ to 20₃, a region between the input ends T11 and T21 and the inversion circuit 11 is defined as a section A, a region between the inversion circuits 11 and 21 is defined as a section B, a region between the inversion circuits 21 and 12 is defined as a section C, a region between the inversion circuits 12 and 22 is defined as a section D, and a region between the inversion circuit 22 and the output ends T19 and T29 is defined as a section E.

The inversion circuits 11, 12, 21, and 22 are alternately arranged in the interconnection direction at alternately offset locations. The inversion circuit 11 is located in the section between the input end T11 and the inversion circuit 21 (A+B), the inversion circuit 21 is located in the section between the inversion circuits 11 and 12 (B+C), the inversion circuit 12 is located in the section between the inversion circuits 21 and 22 (C+D), and the inversion circuit 22 is located in the section between the inversion circuit 12 and the output ends T19 and T29 (D+E).

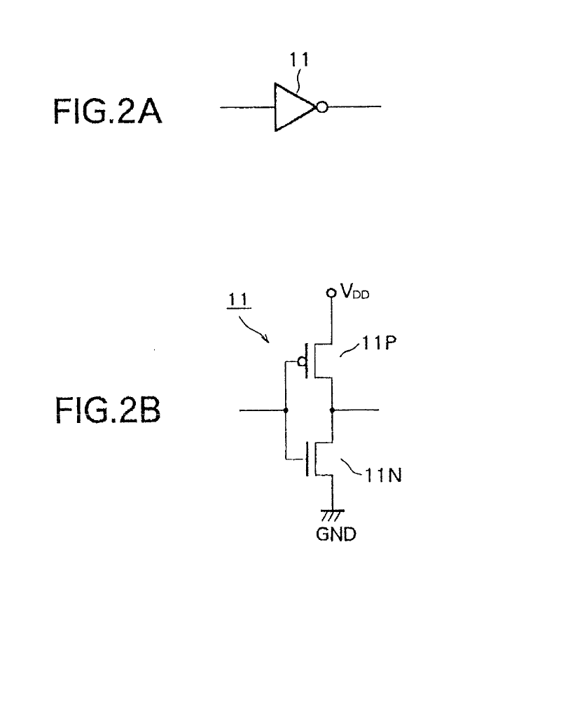

FIG. 2 is a circuit diagram of an example of the inversion circuit 11 in FIG. 1. Note that, the inversion circuits 11, 12, 21, and 22 of FIG. 1 have the same circuit configuration, so an explanation will be given taking as an example the inversion circuit 11.

The inversion circuit 11 shown in FIG. 2A is comprised of a complementary metal oxide semiconductor (CMOS) inverter shown in FIG. 2B.

In the inversion circuit 11 of FIG. 2B, a p-channel type metal oxide semiconductor field effect transistor (MOSFET) 11P and an n-channel type MOSFET 11N are complementarity connected.

A source terminal of the p-channel type MOSFET 11P is supplied with a power supply voltage V_{DD}, and a source terminal of the n-channel type MOSFET 11N is grounded to form a ground potential GND.

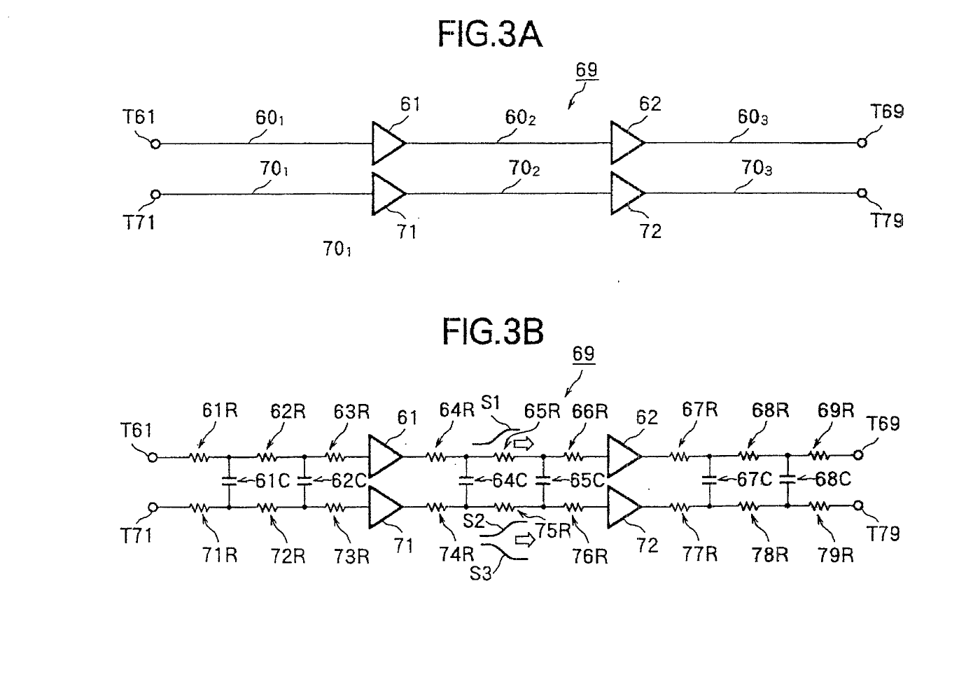

FIGS. 3A and 3B are explanatory views of a circuit of suppressing an influence of crosstalk of the related art.

FIG. 3A is a circuit diagram of this crosstalk circuit 69.

FIG. 3B is a schematic equivalent circuit diagram of the crosstalk suppression circuit 69 of FIG. 3A.

The crosstalk suppression circuit 69 of FIG. 3A has input ends T61 and T71, output ends T69 and T79, interconnections 60₁ to 60₃ and 70₁ to 70₃, and buffers 61, 62, 71, and 72 and is used in an LSI.

The input end T61 and the input end of the buffer 61 are connected by the interconnection 60₁.

The output end of the buffer 61 and the input end of the buffer 62 are connected by the interconnection 60₂.

The output end of the buffer 62 and the output end T69 are connected by the interconnection 60₃.

The input end T71 and the input end of the buffer 71 are connected by the interconnection 70₁.

The output end of the buffer 71 and the input end of the buffer 72 are connected by the interconnection 70₂.

The output end of the buffer 72 and the output end T79 are connected by the interconnection 70₃.

The interconnections 60₁ to 60₃ and the interconnections 70₁ to 70₃ are arranged parallel or substantially parallel.

The buffers 61 and 62 are inserted among the interconnections 60₁ to 60₃, and the buffers 71 and 72 are inserted among the interconnections 70₁ to 70₃.

Each of the buffers 61 and 71 and the buffers 62 and 72 is arranged in a line in the direction vertical to the interconnection direction.

FIG. 3B is a schematic equivalent circuit diagram taking into account the influence of the electric resistance (interconnection resistance) of the interconnections and the parasitic capacity between the interconnections for the crosstalk suppression circuit 69 of FIG. 3A.

The interconnection 60₁ from the input end T61 to the buffer 61 is comprised of serially connected interconnection resistors 61R to 63R.

The interconnection 60₂ between the buffers 61 and 62 is comprised of serially connected interconnection resistors 64R to 66R.

The interconnection 60₃ from the buffer 62 to the output end T69 is comprised of serially connected interconnection resistors 67R to 69R.

The interconnection 70₁ from the input end T71 to the buffer 71 is comprised of serially connected interconnection resistors 71R to 73R.

An interconnection 70₂ between the buffers 71 and 72 is comprised of serially connected interconnection resistors 74R to 76R.

An interconnection 70₃ from the buffer 72 to the output end T79 is comprised of serially connected interconnection resistors 77R to 79R.

There is a parasitic capacity 61C between the interconnection resistors 61R and 62R and the interconnection resistors 71R and 72R.

There is a parasitic capacity 62C between the interconnection resistors 61R and 63R and the interconnection resistors 72R and 73R.

There is a parasitic capacity 64C between the interconnection resistors 64R and 65R and the interconnection resistors 74R and 75R.

There is a parasitic capacity 65C between the interconnection resistors 65R and 66R and the interconnection resistors 75R and 76R.

There is a parasitic capacity 67C between the interconnection resistors 67R and 68R and the interconnection resistors 77R and 78R.

There is a parasitic capacity 68C between the interconnection resistors 68R and 69R and the interconnection resistors 78R and 79R.

In a first case where a signal S1 is propagated to the interconnections 60₁ to 60₃ and a signal S2 is propagated to the interconnections 70₁ to 70₃ and the signals S1 and S2 have the same phase, a potential difference is not produced among the parasitic capacities 61C to 68C or almost no potential difference is produced, so the propagation delay is small, and the delay time becomes the minimum.

In a second case where a signal S1 is propagated to the interconnections 60₁ to 60₃ and there is no propagation of signal to the interconnections 70₁ to 70₃, a potential difference is produced among the parasitic capacities 61C to 68C and the propagation delay becomes large.

In a third case where a signal S1 is propagated to the interconnections 60₁ to 60₃, a signal S3 is propagated to the interconnections 70₁ to 70₃, and the signals S1 and S3 have inverse phases, a potential difference is produced among the parasitic capacities 61C to 68C, the propagation delay becomes further larger, and the delay time becomes the maximum. The parasitic capacity of this third case appears to be twice of the parasitic capacity in the second case, so this parasitic capacity is sometimes referred to as a mirror capacity.

In the crosstalk suppression circuit 69 of FIG. 3, the crosstalk is suppressed by reducing the ratio of the parasitic capacity with respect to the load capacity, so there is the inconvenience of an increase of the number of buffers and consumed power and so on. Also, the larger the number of buffers, the smaller the influence of the crosstalk, but the larger the sum of the buffer delays, so the highest operating speed (or the highest operating frequency) of the LSI is sometimes reduced.

On the other hand, in the crosstalk cancellation circuit 19 of FIG. 1, the parasitic capacity causing crosstalk is not reduced. Instead of this, by arranging an inversion circuit for inverting the signal away from the inversion circuit in the adjacent interconnection (for example arranging it at a location where the distance from the inversion circuit of the adjacent interconnection becomes the maximum) or arranging the same away from the end of the interconnection, partial crosstalk noise is interfered with and canceled out.

By the cancellation of the crosstalk noise, when the parallel interconnection length is long, it is possible to obtain an effect close to shielding.

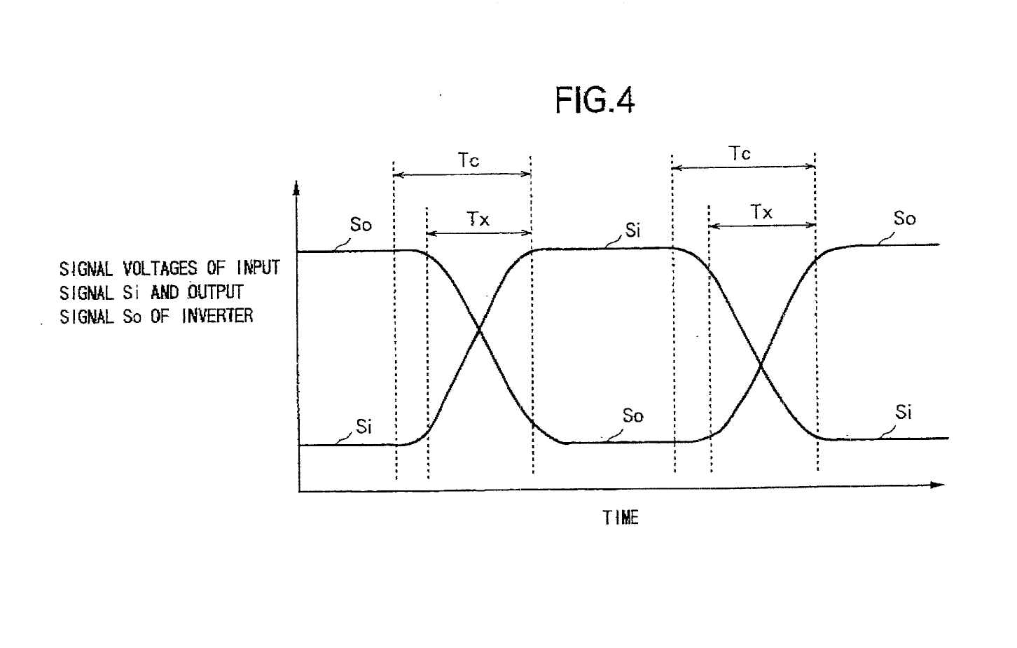

FIG. 4 is an explanatory view of the change of an input signal voltage and an output signal voltage of the inversion circuit 11 in FIG. 1 along with time. An explanation will be given with reference to a CMOS inverter (inverter) having a one-stage configuration of FIG. 2 as the inversion circuit 11.

In this inverter, the signal voltage of an output signal So starts to change around a time when the signal voltage of an input signal Si starts to change and exceeds a threshold voltage of the MOSFET comprising the inverter.

In the crosstalk cancellation circuit 19 in the LSI, the load driven by the inverter is considerably heavy (the load is large). Therefore, an overlap time Tx when the changes of the input signal voltage and the output signal voltage of the inverter overlap becomes nearer the changing time Tc of the input signal voltage.

For this reason, with the arrangement of the inversion circuit (inverter) shown in the crosstalk cancellation circuit 19 of FIG. 1, the crosstalk noise to the adjoining interconnections due to the interconnection of the input side and the interconnection of the output side of the inverter is canceled or substantially canceled by the overlap time Tx on the related adjoining interconnections.

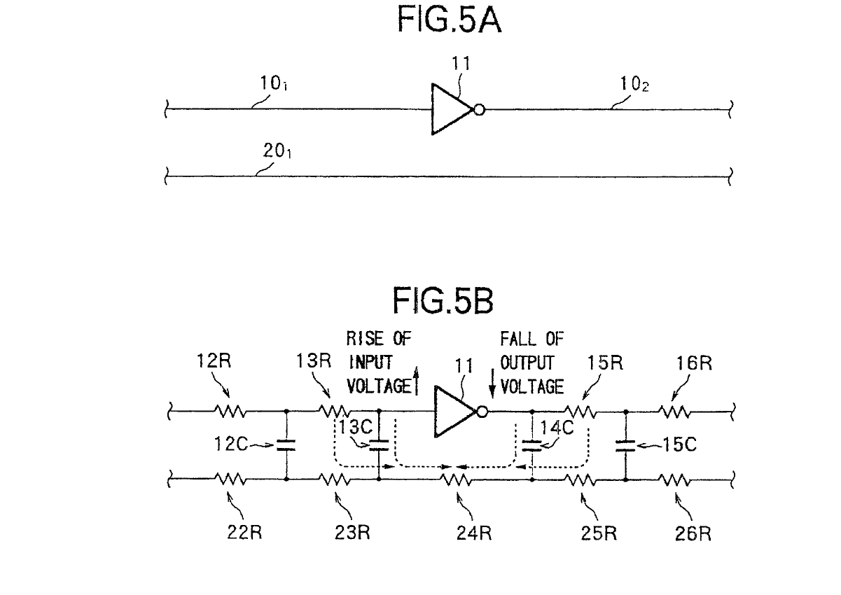

The state of this cancellation of crosstalk noise will be explained using FIGS. 5A and 5B.

FIG. 5A is a partial circuit diagram showing enlarged the vicinity of the inversion circuit 11 in the crosstalk cancellation circuit 19 of FIG. 1.

FIG. 5B is a schematic equivalent circuit diagram taking into account the influence of the interconnection resistance and the parasitic capacity in the partial circuit diagram of FIG. 5A.

In FIG. 5B, the interconnection 10₁ of FIG. 5A is comprised of serially connected interconnection resistors 12R and 13R.

In FIG. 5B, the interconnection 10₂ of FIG. 5A is comprised of serially connected interconnection resistors 15R and 16R.

In FIG. 5B, the interconnection 20₁ of FIG. 5A is comprised of serially connected interconnection resistors 22R to 26R.

There is a parasitic capacity 12C between the interconnection resistors 12R and 13R and the interconnection resistors 22R and 23R.

There is a parasitic capacity 13C between a section from the interconnection resistor 13R to the inversion circuit 11 and the interconnection resistors 23R and 24R.

There is a parasitic capacity 14C between a section from the inversion circuit 11 to the interconnection resistor 15R and the interconnection resistors 24R and 25R.

There is a parasitic capacity 15C between the interconnection resistors 15R and 16R and the interconnection resistors 25R and 26R.

When the input signal voltage and the output signal voltage of the inversion circuit 11 simultaneously change, crosstalk noise is produced by the parasitic capacities 12C and 13C from the interconnection resistors 12R and 13R of the input side of the inversion circuit 11 with respect to the interconnection resistors 22R, 23R, and 24R. At the same time, crosstalk noise is produced by the parasitic capacities 14C and 15C from the interconnection resistors 15R and 16R of the output side of the inversion circuit 11 with respect to the interconnection resistors 24R, 25R, and 26R.

The crosstalk noise produced due to the input signal of the inversion circuit 11 and the crosstalk noise produced due to the output signal cancel each other out or substantially cancel each other out by the interconnection resistor 24R located in the vicinity of the inversion circuit 11.

Accordingly, if the signal changes in the inversion circuit 11, when the signal changes at the same timing on adjoining interconnections (particularly when signal changes of inverse phases occur), the influence of the crosstalk on the propagation delay of the signal is reduced. The influence of the crosstalk is similarly reduced even in a case where there are two or more interconnections.

The above explanation was given of the effect near the inversion circuit 11, but where for example the signal propagation from the input ends T11 and T21 to the output ends T19 and T29 is viewed by FIG. 1 as a whole, other effects are also exhibited.

Here, in the crosstalk cancellation circuit 19 of FIG. 1, a case where signals changing in the same phase are simultaneously input to the input ends T11 and T21 is assumed.

As shown in the explanatory view of FIG. 4, when the delay time of the inversion circuit is smaller than the changing time Tc, the changes of voltage on the interconnections 10₁ to 10₃ and 20₁ to 20₃ of FIG. 1 are propagated from the input ends T11 and T21 to the output ends T19 and T29 like waves between adjoining interconnections at almost the same speed.

At this time, the phases become the same in the section A of FIG. 1, the phases become inverse in the section B, the phases become the same in the section C, the phases become inverse in the section D, and the phases become the same in the section E.

Accordingly, due to the influence of the crosstalk, the propagation delay of the signal becomes large in the sections B and D and becomes small in the sections A, C, and E. As a result, the fluctuations of delays occurring in the different sections canceled each other out, so the total change in delay becomes small.

When signals of inverse phases are input to the input terminals T11 and T21 of the crosstalk cancellation circuit 19 of FIG. 1, the magnitudes of delay for every section become inverse, but the total change in delay similarly becomes small.

Interconnection Module

Next, an explanation will be given of the interconnection module.

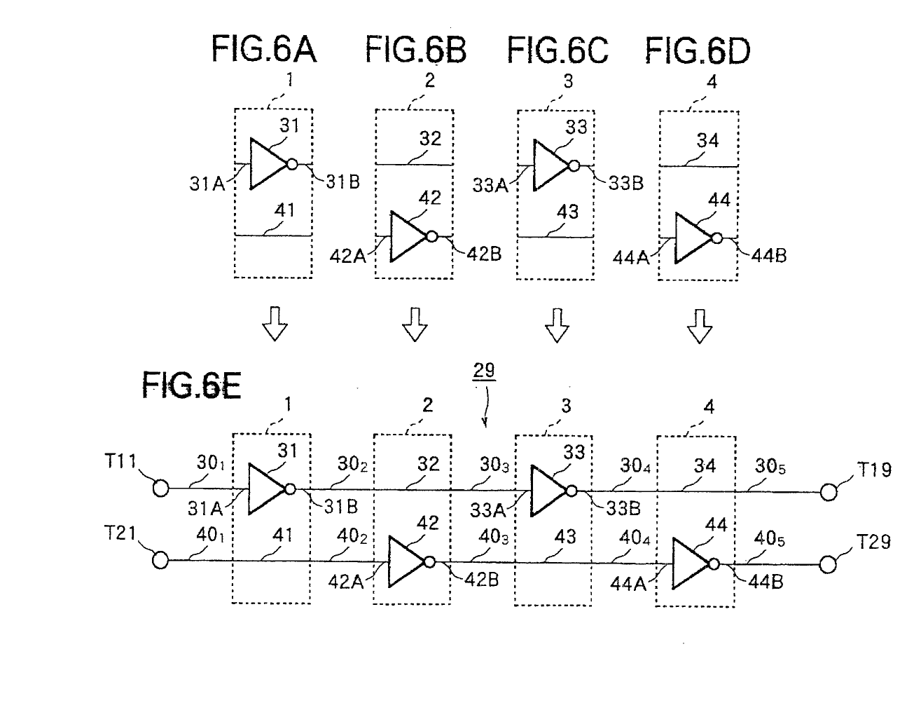

FIGS. 6A to 6E are first explanatory views of interconnection modules useable in the crosstalk cancellation circuit and a crosstalk cancellation circuit created from the related interconnection modules.

FIG. 6A is an explanatory view of an interconnection module 1.

This interconnection module 1 has an inversion circuit 31, an input line 31A and an output line 31B of the inversion circuit 31, and a signal line 41.

FIG. 6B is an explanatory view of an interconnection module 2.

This interconnection module 2 has a signal line 32, an inversion circuit 42, and an input line 42A and an output line 42B of the inversion circuit 42.

FIG. 6C is an explanatory view of an interconnection module 3.

This interconnection module 3 has an inversion circuit 33, an input line 33A and an output line 33B of the inversion circuit 33, and a signal line 43.

FIG. 6D is an explanatory view of an interconnection module 4.

This interconnection module 4 has a signal line 34, an inversion circuit 44, and an input line 44A and an output line 44B of the inversion circuit 44.

The interconnection modules 1 and 3 have identical configurations to each other, while the interconnection modules 2 and 4 have identical configurations to each other.

FIG. 6E is a circuit diagram of a crosstalk cancellation circuit 29 created from the interconnection modules 1 to 4 shown in FIG. 6A to FIG. 6D.

The crosstalk cancellation circuit 29 of FIG. 6E has the input ends T11 and T21, interconnections 30₁ to 30₅ and 40₁ to 40₅, interconnection modules 1 to 4, and output ends T19 and T29. This crosstalk cancellation circuit 29 has a connection configuration as shown below.

The input end T11 and the input line 31A of the inversion circuit 31 of the interconnection module 1 are connected by the interconnection 30₁.

The input end T21 and the input end of the signal line 41 of the interconnection module 1 are connected by the interconnection 40₁.

The output line 31B of the inversion circuit 31 of the interconnection module 1 and the input end of the signal line 32 of the interconnection module 2 are connected by the interconnection 30₂.

The output end of the signal line 41 of the interconnection module 1 and the input line 42A of the inversion circuit 42 of the interconnection module 2 are connected by the interconnection 40₂.

The output end of the signal line 32 of the interconnection module 2 and the input line 33A of the inversion circuit 33 of the interconnection module 3 are connected by the interconnection 30₃.

The output line 42B of the inversion circuit 42 of the interconnection module 2 and the input end of the signal line 43 of the interconnection module 3 are connected by the interconnection 40₃.

The output line 33B of the inversion circuit 33 of the interconnection module 3 and the input end of the signal line 34 of the interconnection module 4 are connected by the interconnection 30₄.

The output end of the signal line 43 of the interconnection module 3 and the input line 44A of the inversion circuit 44 of the interconnection module 4 are connected by the interconnection 40₄.

The output end of the signal line 34 of the interconnection module 4 and the output end T19 are connected by the interconnection 30₅.

The output line 44B of the inversion circuit 44 of the interconnection module 4 and the output end T29 are connected by the interconnection 40₅.

In this way, the crosstalk cancellation circuit 29 of FIG. 6E can be created by using the interconnection modules 1 to 4 of FIGS. 6A to 6D. In this crosstalk cancellation circuit 29, it is possible to transfer two bits of parallel data while suppressing the crosstalk noise and suppressing the time difference of the delay times.

Also, it is possible to obtain the crosstalk cancellation circuit 19 of FIG. 1 by replacing the inversion circuits 31, 33, 42, and 44 in FIG. 6E by the inversion circuits 11, 12, 21, and 22. The interconnection modules 1 to 4 are used inserted into for example the interconnections of data buses or address buses in the LSI.

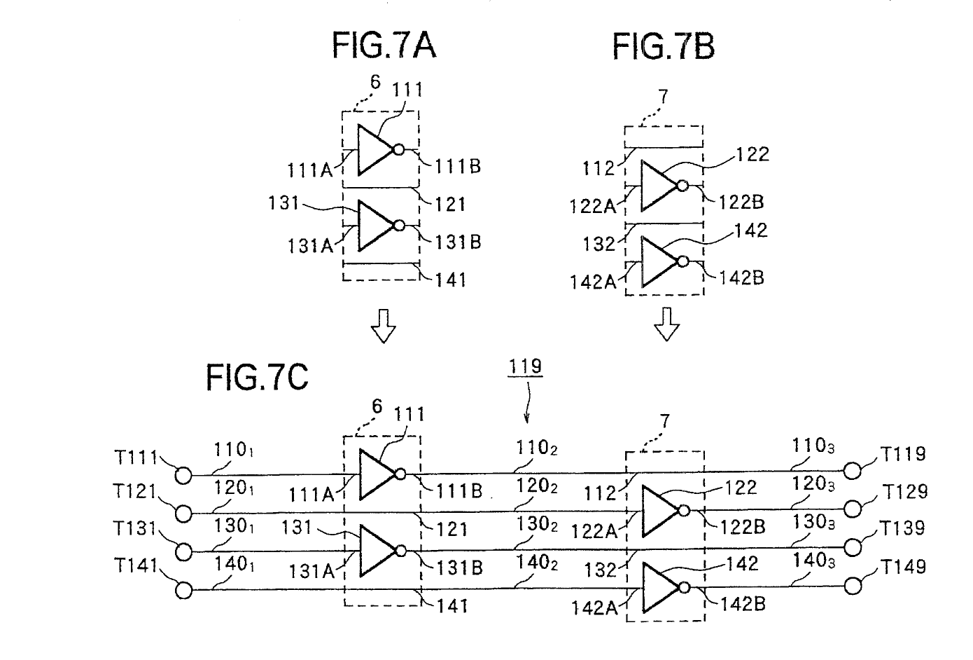

FIGS. 7A to 7C are second explanatory views of the interconnection modules useable in the crosstalk cancellation circuit and the crosstalk cancellation circuit created from the related interconnection modules.

FIG. 7A is an explanatory view of an interconnection module 6.

This interconnection module 6 has inversion circuits 111 and 131, input lines 111A and 131A and output lines 111B and 131B of the inversion circuits Ill and 131, and signal lines 121 and 141.

In the interconnection module 6, the inversion circuits 111 and 131 and the signal lines 121 and 141 are alternately arranged.

The input lines 111A and 131A, the output lines 111B and 131B, and the signal lines 121 and 141 are arranged parallel or substantially parallel to each other.

The inversion circuits 111 and 131 are arranged so as to be parallel in the direction vertical or substantially vertical to the direction in which the signal lines 121 and 141 are extended (direction of the signal lines).

FIG. 7B is an explanatory view of an interconnection module 7.

This interconnection module 7 has signal lines 112 and 132, inversion circuits 122 and 142, and input lines 122A and 142A and output lines 122B and 142B of the inversion circuits 122 and 142.

In the interconnection module 7, the inversion circuits 122 and 142 and the signal lines 112 and 132 are alternately arranged.

The input lines 122A and 142A, the output lines 122B and 142B, and the signal lines 112 and 132 are arranged parallel or substantially parallel to each other.

The inversion circuits 122 and 142 are arranged so as to be parallel in the direction vertical or substantially vertical to the direction in which the signal lines 112 and 132 are extended (direction of the signal lines).

The inversion circuits 111, 122, 131, and 142 have identical configurations to each other.

FIG. 7C is a circuit diagram of a crosstalk cancellation circuit 119 created from the interconnection modules 6 and 7 shown in FIGS. 7A and 7B.

The crosstalk cancellation circuit 119 of FIG. 7C has input ends T111 to T141, interconnections 110₁ to 110₃, 120₁ to 120₃, 130₁ to 130₃, and 140₁ to 140₃, interconnection modules 6 and 7, and output ends T119 to T149. This crosstalk cancellation circuit 119 has the following connection configuration.

The input end T111 and the input line 111A of the inversion circuit 111 of the interconnection module 6 are connected by the interconnection 110₁.

The input end T131 and the input line 131A of the inversion circuit 131 of the interconnection module 6 are connected by the interconnection 130₁.

The input end 121T and the input end of the signal line 121 of the interconnection module 6 are connected by the interconnection 120₁.

The input end 141T and the input end of the signal line 141 of the interconnection module 6 are connected by the interconnection 140₁.

The output line 111B of the inversion circuit 111 of the interconnection module 6 and the input end of the signal line 112 of the interconnection module 7 are connected by the interconnection 110₂.

The output line 1131B of the inversion circuit 131 of the interconnection module 6 and the input end of the signal line 132 of the interconnection module 7 are connected by the interconnection 130₂.

The output end of the signal line 121 of the interconnection module 6 and the input line 122A of the inversion circuit 122 of the interconnection module 7 are connected by the interconnection 120₂.

The output end of the signal line 141 of the interconnection module 6 and the input line 142A of the inversion circuit 142 of the interconnection module 7 are connected by the interconnection 140₂.

The output end of the signal line 112 of the interconnection module 7 and the output end T119 are connected by the interconnection 110₃.

The output end of the signal line 132 of the interconnection module 7 and the output end T139 are connected by the interconnection 130₃.

The output line 122B of the inversion circuit 122 of the interconnection module 7 and the output end T129 are connected by the interconnection 120₃.

The output line 142B of the inversion circuit 142 of the interconnection module 7 and the output end T149 are connected by the interconnection 140₃.

In this way, the crosstalk cancellation circuit 119 of FIG. 7C can be created by using the interconnection modules 6 and 7 of FIGS. 7A and 7B.

In this crosstalk cancellation circuit 119, it is possible to transfer four bits of parallel data while suppressing the crosstalk noise and suppressing the difference of the delay times. The interconnection modules 6 and 7 are inserted into for example the interconnections of the data buses or address buses in the LSI and comprise part of the related data buses or address buses.

Case 1

As an example, a case where an interconnection length is set to 5 mm and two CMOS inverters are inserted into both interconnections for two parallel interconnections prepared by a process rule of 0.25 micrometer (or 0.25 μm) is assumed. For example, an interconnection width is set at about 0.8 μm, an interconnection interval is set at about 0.9 μm, an interconnection resistance value is set at about 50 Ω/mm, a power supply voltage V_{DD} of the CMOS inverter is set at about 2.5V, and a logic threshold value of the CMOS inverter is set at about 1.1V.

A case where the CMOS inverters are arranged in the vicinity of the input ends of the two interconnections and, at the same time, the CMOS inverters are arranged in the vicinity of the output ends of the two interconnections will be considered as a case 1W.

A case where the CMOS inverters are arranged in the vicinity of the input ends of the two interconnections, the CMOS inverter is arranged in the vicinity of the output end of one interconnection, and the CMOS inverter is arranged at a center portion of the other interconnection will be considered as a case 1A.

Where a first signal is input to one interconnection, a second signal is input to the other interconnection, and the first and second signals have inverse phases, it is possible to control the delay time of the case 1A to about 72% of the delay time of the case 1W.

Also, it is possible to control the delay time difference of the case 1A to about 34% of the delay time difference of the case 1W for the case where the first signal is input to one interconnection, the second signal is input to the other interconnection, and the first and second signals have inverse phases or the first and second signals have the same phase.

Case 2

As an example, a case where the interconnection length is set to 10 mm and four CMOS inverters are inserted into each interconnection for two parallel interconnections prepared by the process rule of 0.25 micrometer (or 0.25 μm) is assumed. For example, the interconnection width is set at about 0.8 μm, the interconnection interval is set at about 0.9 μm, the interconnection resistance value is set at about 50 Ω/mm, the power supply voltage V_{DD} of the CMOS inverter is set at about 2.5V, and the logic threshold value of the CMOS inverter is set at about 1.1V.

A case where the CMOS inverters are arranged in the vicinity of the input ends and output ends of the two interconnections and, at the same time, the CMOS inverters are arranged at two locations equally dividing each interconnection to three will be considered as a case 2W.

A case where the CMOS inverters are arranged in the vicinity of the input ends and output ends of the two interconnections, the CMOS inverters are arranged at first and third locations from the input end in one interconnection among locations equally dividing each interconnection to five, and the CMOS inverters are arranged at second and fourth locations from the input end in the other interconnection will be considered as a case 2A.

When the first signal is input to one interconnection, the second signal is input to the other interconnection, and the first and second signals have inverse phases, it is possible to control the delay time of the case 2A to about 72% of the delay time of the case 2W.

Also, it is possible to control the delay time difference of the case 2A to about 12% of the delay time difference of the case 2W for the case where the first signal is input to one interconnection, the second signal is input to the other interconnection, and the first and second signals have inverse phases, or the first and second signals have the same phase.

Case 3

As an example, a case where the interconnection length is set to 20 mm and six CMOS inverters are inserted into each interconnection for two parallel interconnections prepared by the process rule of 0.25 micrometer (or 0.25 μm) is assumed. For example, the interconnection width is set at about 0.8 μm, the interconnection interval is set at about 0.9 μm, the interconnection resistance value is set at about 50 Ω/mm, the power supply voltage V_{DD} of the CMOS inverter is set at about 2.5V, and the logic threshold value of the CMOS inverter is set at about 1.1V.

A case where the CMOS inverters are arranged in the vicinity of the input ends and output ends of the two interconnections and, at the same time, the CMOS inverters are arranged at four locations equally dividing each interconnection to five will be considered as a case 3W.

A case where the CMOS inverters are arranged in the vicinity of the input ends and output ends of the two interconnections, the CMOS inverters are arranged at odd number locations from the input end in one interconnection among eight locations equally dividing each interconnection to nine, and the CMOS inverters are arranged at even number locations from the input end in the other interconnection will be considered as a case 3A.

When the first signal is input to one interconnection, the second signal is input to the other interconnection, and the first and second signals have inverse phases, it is possible to control the delay time of the case 3A to about 73% of the delay time of the case 3W.

Also, it is possible to control the delay time difference of the case 3A to about 9% of the delay time difference of the case 3W for the case where the first signal is input to one interconnection, the second signal is input to the other interconnection, and the first and second signals have inverse phases or the first and second signals have the same phase.

In this way, according to the crosstalk cancellation circuit, it is possible to obtain an effect close to shielding.

Note that, an explanation will be given with reference to two parallel interconnections prepared by the process rule of 0.25 micrometer, but it can be similarly applied also with respect to two parallel interconnections (or LSI) prepared by a process rule of 0.18 micrometer or less.

Interconnection Method of Automatic Interconnection Apparatus

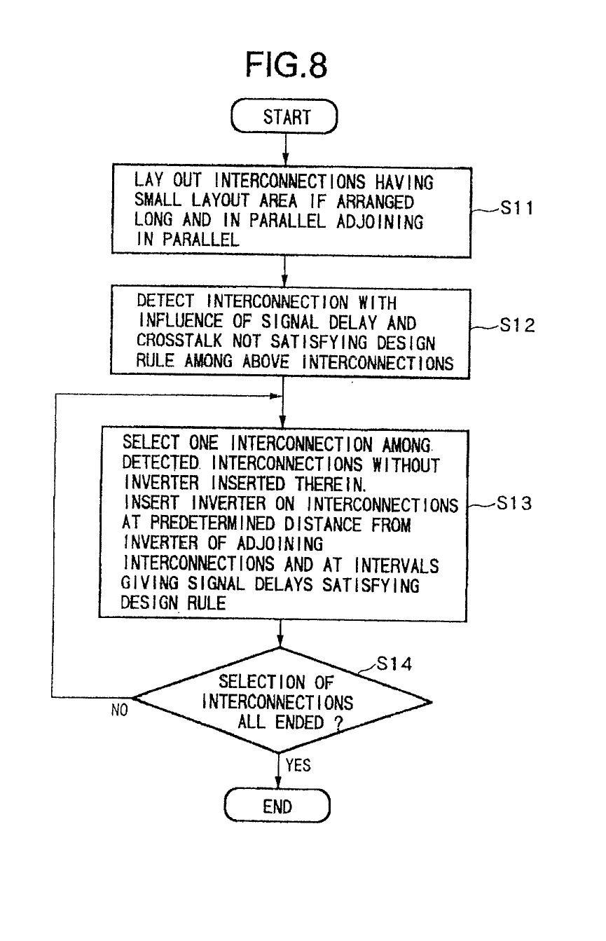

FIG. 8 is a schematic flowchart of a first interconnection method of an automatic interconnection apparatus for laying out interconnections in an LSI which lays out interconnections of the crosstalk cancellation circuit. The automatic interconnection apparatus is mounted as an apparatus for achieving an automatic layout function in for example a computer aided design (CAD) system.

The interconnections in the LSI are comprised as data bus or address bus interconnections. Also, the LSI is used as a semiconductor integrated circuit manufactured by for example the process rule of 0.25 micrometer or less.

First, at step S11, a plurality of interconnections which would have a small layout area if arranged in parallel over a long distance are detected and the plurality of interconnections are arranged adjacent in parallel. For example, bus interconnections such as address buses or data buses are laid in parallel adjoining each other over a long distance.

Next, at step S12, interconnections with effects of signal delay and crosstalk not satisfying the design rule are detected among the parallel interconnections of step S11. For example, interconnections having a larger signal delay than the set value (or permissible value) and interconnections having a large crosstalk noise are detected.

At step S13, one interconnection among the interconnections detected at step S12, without the inversion circuit inserted therein, is selected.

Then, an inversion circuit is inserted on the related interconnection at a predetermined distance from the inversion circuit on the adjacent interconnection and at an interval whereby the signal delay satisfies the design rule.

The location a predetermined distance away is set to a location where the crosstalk noise due to the parasitic capacity of the adjoining interconnections is canceled out or substantially canceled out on the related adjoining interconnections.

Also, the inversion circuits are inserted into the interconnections adjoining each other among the plurality of interconnections at alternating offset locations.

At this step S13, the same number of inversion circuits are arranged at each of the interconnections detected at step S12. The inversion circuit has the characteristic that the time when the input signal voltage changes and the time when the output signal voltage changes overlap. Also, the inversion circuits inserted at each of the plurality of interconnections are inversion circuits having the same configuration.

The locations of insertion of the inversion circuits are preferably locations where the distance with respect to one interconnection between adjoining interconnections from the inversion circuits of the other interconnection becomes the maximum or the vicinity of those locations.

Then, more preferably, the difference between the maximum delay time and the minimum delay time in the case where the inversion circuits are arranged at alternately offset locations with respect to two adjoining interconnections is controlled so as to be not more than the half of the time difference between the maximum delay time and the minimum delay time in the case where each two such inversion circuits are arranged in line in the direction vertical to the interconnection direction.

At step S14, it is judged whether or not the selection operations of the interconnections at step S13 have all been finished.

When not all of the selection operations of the interconnections are finished, the routine returns to step S13.

When all of selection operations of the interconnections are finished, the processing of the present flowchart is ended. In this way, it is possible to lay out the interconnection of the crosstalk cancellation circuit in the LSI.

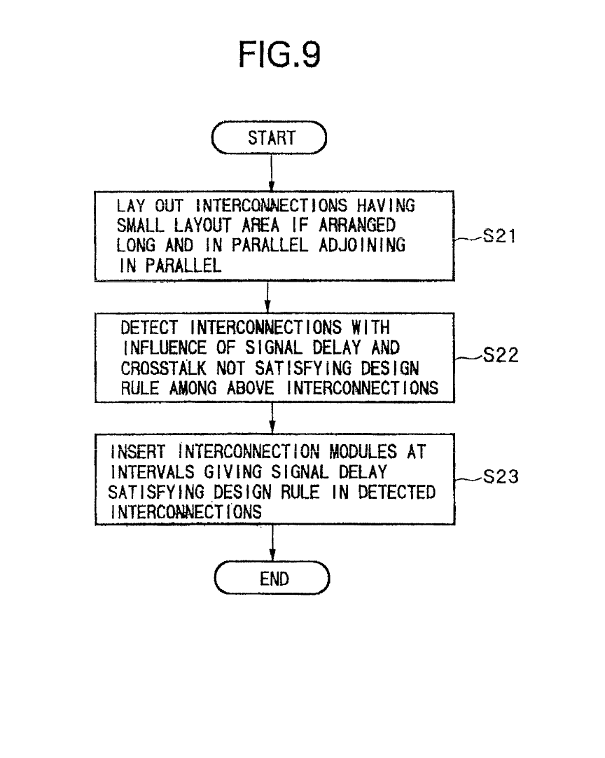

FIG. 9 is a schematic flowchart of a second interconnection method of an automatic interconnection apparatus for laying out the interconnections in the LSI which lays out the interconnections of the crosstalk cancellation circuit by using the interconnection module. The automatic interconnection apparatus is comprised of for example a CAD system.

The interconnections in the LSI are for example data bus or address bus interconnections. Also, the LSI is made a semiconductor integrated circuit manufactured by the process rule of 0.25 micrometer or less.

Steps S21 and S22 are the same as steps S11 and S12 of FIG. 8, so the explanations thereof will be omitted.

At step S23, the interconnection modules are inserted at intervals with respect to the interconnections detected at step S22 to give signal delays satisfying the design rule and to create the crosstalk cancellation circuit in the LSI.

By the flowchart shown in FIG. 9, it is possible to lay out similar interconnections to the interconnections obtained by the flowchart shown in FIG. 8.

By the crosstalk cancellation circuits 19, 29, and 119, it is possible to reduce the variation of the signal delays due to the crosstalk between adjoining interconnections, the hold time error of the latch circuit such as a DFF can be prevented, and it is possible to raise the highest operating frequency of LSI.

Also, the crosstalk cancellation circuits 19, 29, and 119 can be easily prepared by using the automatic interconnection apparatus by the interconnection modules 1 to 4, 6, and 7. It is therefore possible to reduce the trouble of preparation of the crosstalk cancellation circuit.

Also, by adding the interconnection function of the interconnection modules 1 to 4, 6, and 7 to the automatic interconnection apparatus of the related art, the crosstalk cancellation circuits 19, 29, and 119 can be easily designed and/or prepared.

Note that the above embodiments are examples of the present invention, but the present invention is not limited to the embodiments.

As explained above, according to the present invention, a crosstalk cancellation circuit capable of suppressing the crosstalk noise of the interconnections in a LSI, an interconnection module useable in this crosstalk cancellation circuit, and an interconnection method of an automatic interconnection apparatus capable of laying out the interconnections of the crosstalk cancellation circuit in the LSI can be provided.

What is claimed is:

1. A crosstalk cancellation circuit for suppressing crosstalk noise of interconnections in an integrated circuit, comprising:
N (N is an even number of 2 or more) number of first inverters;
a first interconnection for connecting the N number of first inverters in series;
N number of second inverters; and
a second interconnection for connecting said N number of second inverters in series, and
wherein said first and second interconnections are arranged adjacent in parallel or substantially parallel to each other,
wherein at least one first inverters among said N number of first inverters is arranged at a location where crosstalk noise due to a parasitic capacity between said first and second interconnections is canceled out or substantially canceled out on said second interconnection, and
wherein at least one second inverter among said N number of second inverters is arranged at a location where crosstalk noise due to a parasitic capacity between said first and second interconnections is canceled out or substantially canceled out on said first interconnection.

2. A crosstalk cancellation circuit as set forth in claim 1, wherein
said N number of first inverters are arranged in the approximately same interval in said first interconnection, and
said N number of second inverters are arranged in said second interconnection at the middle positions where distances from the adjacent first inverters are equal.

3. A crosstalk cancellation circuit as set forth in claim 1, wherein,
in each of said N number of first inverters, a time when an input signal voltage of the related first inverter changes and a time when an output signal voltage changes overlap, and
in each of said N number of second inverters, a time when the input signal voltage of the related second inverter changes and a time when the output signal voltage changes overlap.

4. A crosstalk cancellation circuit as set forth in claim 1, wherein said N number of first and second inverters and said first and second interconnections comprise buses in said integrated circuit.

5. A crosstalk cancellation circuit as set forth in claim 1, wherein said N number of first and second inverters are inverters having the same configuration.

6. An interconnection module in an integrated circuit, comprising:
M (M is a natural number) number of inverters;
input lines of said M number of inverters;
output lines of said M number inverters; and
L number of signal lines, and
wherein said input lines, said output lines, and said signal lines are parallel or substantially parallel to each other, and wherein said inverters, input lines, and output lines of the related inverters and said signal lines are alternately arranged (note, where M=1, L=M or L=M+1 and where M≧2, L=M, L=M+1, or L=M−1).

7. An interconnection module as set forth in claim 6, wherein
M is an integer of 2 or more, and
said M number of inverters are arranged so as to be parallel in a direction vertical or substantially vertical to the direction of said signal lines.

8. An interconnection module as set forth in claim 6, wherein said integrated circuit is configured as a semiconductor integrated circuit manufactured by a process rule of less than 0.25 micrometer.

9. A method of interconnection of an automatic interconnection apparatus for laying out interconnections in an integrated circuit, comprising the steps of:
a first step of arranging a plurality of interconnections parallel or substantially parallel; and
a second step of inserting the same number of inverters at said plurality of interconnections, and
wherein said second step having a third step of inserting each inverter at a location where crosstalk noise due to a parasitic capacity of the adjoining interconnections is canceled out or substantially canceled out on the related adjoining interconnections.

10. A method of interconnection of an automatic interconnection apparatus as set forth in claim 9, wherein, in said third step, said inverters are inserted at alternate locations with respect to the interconnections adjoining each other among said plurality of interconnections.

11. A method of interconnection of an automatic interconnection apparatus as set forth in claim 9, wherein, in said third step, each inverter is inserted at one interconnection between interconnections adjoining each other at a location where the distance from the inverter of the other interconnection becomes the maximum or in the vicinity of that location.

12. A method of interconnection of an automatic interconnection apparatus as set forth in claim 9, wherein a time when an input signal voltage changes and a time when an output signal voltage changes overlap.

13. A method of interconnection of an automatic interconnection apparatus as set forth in claim 9, wherein said interconnections are interconnections of buses.

14. A method of interconnection of an automatic interconnection apparatus as set forth in claim 9, wherein said integrated circuit is configured as a semiconductor integrated circuit manufactured by a process rule of less than 0.25 micrometer.

15. A method of interconnection of an automatic interconnection apparatus as set forth in claim 9, wherein the inverters inserted at said plurality of interconnections are inverters having the same configuration.

16. An integrated circuit comprising
a crosstalk cancellation circuit for suppressing crosstalk noise of interconnections in an integrated circuit, and
wherein said crosstalk cancellation circuit comprises
N (N is an even number of 2 or more) number of first inverters,
a first interconnection for connecting the N number of first inverters in series, N number of second inverters, and
a second interconnection for connecting said N number of second inverters in series, and
Wherein said first and second interconnections are arranged adjacent in parallel or substantially parallel to each other,
wherein at least one first inverters among said N number of first inverters is arranged at a location where crosstalk noise due to a parasitic capacity between said first and second interconnections is canceled out or substantially canceled out on said second interconnection, and
wherein at least one second inverter among said N number of second inverters is arranged at a location where crosstalk noise due to a parasitic capacity between said first and second interconnections is canceled out or substantially canceled out on said first interconnection.
